(19) United States
(12) Patent Application Publication
(10) Pub. No.: US 2011/0195145 A1
(43) Pub. Date: Aug. 11, 2011

(54) PRODUCT AND METHOD FOR ADDING CAFFEINE TO BEVERAGES

(75) Inventors: Ofir MORENO, Hesperia, CA (US); Ayal MORENO, Venice, CA (US)

(73) Assignee: BODY FORTH, LLC, Hesperia, CA (US)

(21) Appl. No.: 12/890,394

(22) Filed: Sep. 24, 2010

Related U.S. Application Data
(60) Provisional application No. 61/277,504, filed on Sep. 25, 2009.

(51) Int. Cl. A23L 2/52

(52) U.S. Cl. 426/2; 426/115

(57) ABSTRACT

A product and method that enable the convenient addition of an unbuffered concentrated caffeine aqueous solution to beverages prior to consumption, without significantly affecting the volume of the beverage or the taste of the beverage beyond the taste of the caffeine itself.

### CROSS-REFERENCES TO RELATED APPLICATIONS

This application claims the benefit of priority to U.S. Provisional Application No. 61/277,504 filed on Sep. 25, 2009, the contents of which is incorporated herein by reference.

### FIELD OF THE INVENTION

The present invention relates to a product that allows consumers to conveniently add caffeine to their beverages of choice, without significantly affecting the taste of the beverage beyond the taste of the caffeine itself. In particular, the present invention relates to the addition of an unbuffered highly concentrated caffeine solution to a beverage, where the caffeine solution employs niacinamide as a solubilizing agent, and the volume is sufficiently small to allow convenient addition and mixing to a pre-packaged beverage of choice.

### BACKGROUND OF THE INVENTION

Caffeine is a widely used stimulant and antisoporific, available in a wide variety of dosage forms. A popular form of administration is in the form of a caffeinated beverage. However, consumers desiring such a dosage form must typically purchase a beverage manufactured to contain caffeine, since no convenient method exists to add caffeine to an otherwise preferred beverage. Therefore, it is desirable for the consumer to have the option of adding caffeine to a beverage of choice. Furthermore, it is desirable to have the option of doing so without significantly altering the taste of the beverage.

Coffee is one of the most popular beverages for the consumption of caffeine, where one cup of coffee, or a shot of espresso, is widely recognized and utilized to provide a desirable dose of caffeine. Although the amount of caffeine in coffee varies, it is estimated that the average is approximately 90 mg per cup. Additionally, the FDA recommended dosage of caffeine, for purposes of realizing its stimulant effect, is 100 to 200 milligrams not more often than every 3 to 4 hours. Therefore, it is desirable for a product and method to enable the addition of at least 90 mg, and up to 200 mg of caffeine to a single serving beverage of choice.

### SUMMARY OF THE INVENTION

In order for the addition of a concentrated caffeine solution to a commercial beverage to be convenient, and to allow for thorough mixing in a timely fashion, it should comprise a volume that fits within the headspace of commercial beverage containers, while still allowing ample room for mixing. Furthermore, to minimize the dilutive impact of the added volume on taste, the volume should be insignificant relative to the volume of the beverage; preferably 1% of the beverage volume or less. For beverage volumes of 8, 12, 16 and 20 oz, that would correspond to approximately 3, 5, 7 and 8 ml, respectively. Since the volume of beverages sold in single serving containers is 8-20 oz, a volume of concentrated caffeine solution of 3-8 ml is suitable depending on serving size, where smaller volumes are preferred for broader application, and a volume of less than 3 ml would be most preferred for broadest application.

Due to the limited water solubility of caffeine, such a product would require a solubilizing agent to achieve the desired concentration of caffeine. There are many solubilizing agents that are reported to raise the solubility of caffeine to such levels, such as citric acid, ascorbic acid, niacin, niacinamide, phosphoric acid, hydrochloric acid, and sodium benzoate. However, they all impart a taste, depending on the amount used. Prior art neither discloses nor anticipates the identity nor amount of solubilizing agent(s) that will simultaneously meet the product's volume and taste requirements described above. Therefore, an unmet need exists where the solution is neither disclosed nor anticipated by prior art.

Therefore, one aspect of the invention provides for a product that allows for the convenient addition of an unbuffered oral caffeine dosage to a pre-packaged beverage. Certain combinations of niacinamide and caffeine allow the production of concentrated caffeine solutions in small enough volumes that the solution can be conveniently added to a pre-packaged beverage and mixed into the beverage without significantly altering the taste of the beverage beyond the flavor of the added caffeine. The use of niacinamide as a solubilizing agent is a critical factor in achieving the aqueous caffeine solution. The concentrated caffeine solutions of the present invention are composed such that the amount metered for dispensation is less than 8 ml, and contains between 20-150 mg of niacinamide, and an amount of caffeine up to the maximum solubility of caffeine in the aqueous niacinamide solution, preferably 90-200 mg of caffeine. The aqueous solution does not require buffering agents nor does it require artificial sweeteners or any other taste masking agent to hide the taste of the aqueous solution.

The aqueous solution can be packaged in single unit dose containers, such as plastic ampoules or pouches. The aqueous solution can also be packaged in a multi-dose container capable of delivering multiple doses of the product to different pre-packaged beverages at different times, such as a bottle-top metered pump or a metered liquid dispensing gun. In one embodiment of the invention, the aqueous solution is comprised of less than 200 mg niacinamide and caffeine in an amount equal to the maximum solubility of the caffeine, wherein the total volume of the aqueous solution is less than 8 ml. In a preferred embodiment of the invention, the total volume is less than 5 ml. In another preferred embodiment of the invention the total volume of the product is less than 3 ml. In another embodiment of the invention, the amount of niacinamide is between 20-150 mg. In yet another preferred embodiment of the invention, the aqueous solution contains about 200 mg or less of caffeine. In an especially preferred embodiment, the aqueous solution contains about 100 mg of caffeine.

Another aspect of the present invention provides a method for delivering a controlled amount of caffeine to a person in need of or desirous of receiving the caffeine, comprising the steps of adding an unbuffered concentrated caffeine aqueous solution product to a pre-packaged beverage of choice prior to consumption, and consuming the contents of the pre-packaged beverage with the aqueous caffeine solution. In a preferred embodiment of the invention the aqueous caffeine solution does not alter the taste of the pre-packaged beverage beyond the taste of the caffeine. In another preferred embodiment of the invention, the aqueous caffeine solution is packaged in single or multi-dose containers that deliver 8 ml or less of the solution to the beverage. In another preferred embodiment of the invention, the aqueous caffeine solution is packaged in single or multi-dose containers that deliver 7 ml or less of the solution to the beverage. In another preferred embodiment of the invention, the aqueous caffeine solution is packaged in single or multi-dose containers that deliver 5 ml or less of the solution to the beverage. In an especially preferred embodiment of the invention, the volume of the solution is 3 ml or less. In yet another preferred embodiment, the aqueous caffeine solution contains 200 mg or less of caffeine.

### BRIEF DESCRIPTION OF THE FIGURES

FIG. 1: FIG. 1 depicts an ampoule which may be manufactured and filled with the product of the invention via a process (e.g. blow-fill-seal) that fits the ampoule with a top that can be conveniently removed. The top is removed to open the ampoule, and the contents are poured out.

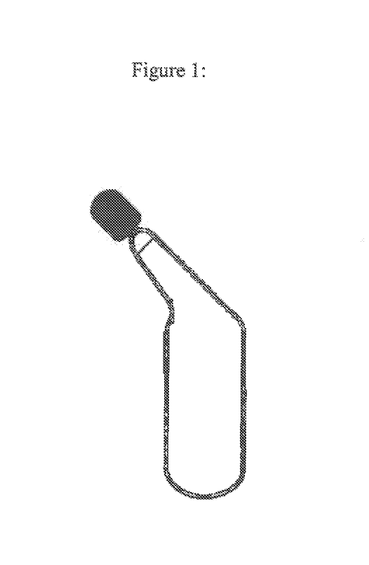

FIG. 2: FIG. 2 depicts a pouch which may be manufactured and filled with the product of the invention via a process (e.g. form-fill-seal) that allows the pouch to be conveniently opened at one end. The end is torn or cut off to open the pouch, and the contents are poured out.

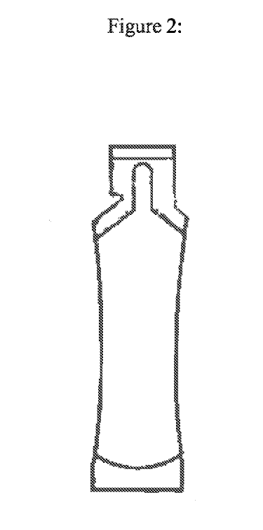

FIG. 3: A bottle fitted with a hand-pump configured to dispense a metered amount of liquid when depressed. The bottle may be filled with the product of the invention to allow for metered dispensing of the product.

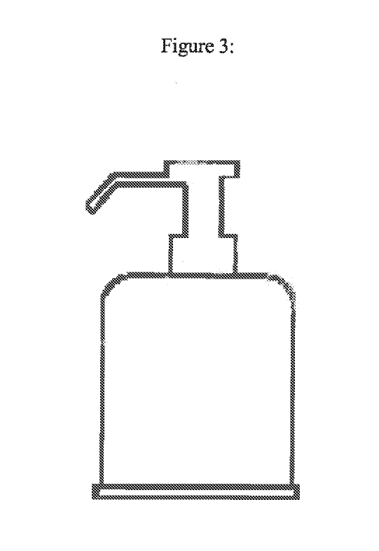

FIG. 4: A pump gun configured to dispense a metered amount of liquid when the trigger is squeezed. The pump gun may be filled with the product of the invention to allow for metered dispensing of the product

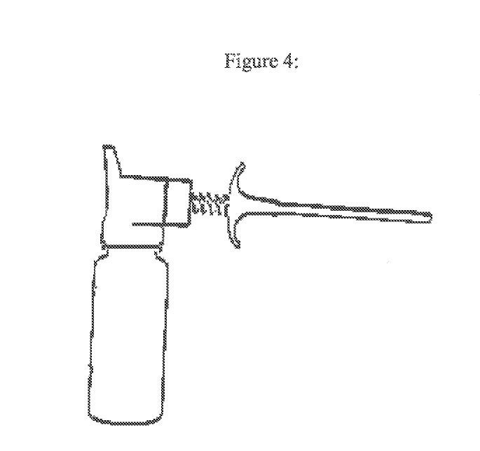

### DETAILED DESCRIPTION OF THE INVENTION

The present invention relates to a product comprised of caffeine and niacinamide dissolved in water to produce a concentrated solution of caffeine, up to the maximum solubility of the caffeine, where the solution is packaged to allow metered dispensation of 8 ml or less to a pre-packaged beverage for consumption by an individual.

One aspect of the invention relates to the use of niacinamide as a solubilizing agent, in proportions that allow for desired concentrated caffeine doses in aqueous solutions of less than 8 ml, without significantly affecting the taste of the beverage to which the solution is added. Lower amounts of niacinamide reduce caffeine solubility, and higher amounts may adversely impact taste. Limitations are neither reported nor anticipated by prior art, and so were necessarily empirically derived.

It has been discovered through taste testing, that it is desirable for the amount of concentrated caffeine solution dispensed into a single beverage in a metered dose should not exceed 150 mg of niacinamide.

It is desirable for the metered amount to dispense up to 200 mg of caffeine in a volume less than 8 ml. It has been found that at least 20 mg of niacinamide is desirable to achieve that level of solubility.

Consequently, the concentrated caffeine solutions of the present invention are composed such that the amount metered for dispensation is less than 8 ml, and contains between 20-150 mg of niacinamide, and an amount of caffeine up to the maximum solubility of caffeine in the aqueous niacinamide solution, preferably 90-200 mg of caffeine.

The aqueous solution can be packaged to allow for ease of delivery to the pre-packaged beverage by the consumer. The aqueous solution can be packaged in single unit dose containers, such as plastic ampoules or pouches. The aqueous solution can also be packaged in a multi-dose container capable of delivering multiple doses of the product to different pre-packaged beverages at different times, such as a bottle-top metered pump or a metered liquid dispensing gun.

Another aspect of the invention relates to the convenient dispensation of metered amounts of the above solution into a beverage of choice, for purposes of delivering a controlled amount of caffeine to a person in need of or desirous of receiving the caffeine, comprising the steps of adding an unbuffered concentrated caffeine aqueous solution product to a pre-packaged beverage of choice prior to consumption, and consuming the contents of the pre-packaged beverage with the aqueous caffeine solution. In a preferred embodiment of the invention the aqueous caffeine solution does not alter the taste of the pre-packaged beverage beyond the taste of the caffeine. In another preferred embodiment of the invention, the aqueous caffeine solution is packaged in single or multi-dose containers that deliver 8 ml or less of the solution to the beverage. In an especially preferred embodiment of the invention, the volume of the solution is 4 ml or less. In yet another preferred embodiment, the aqueous caffeine solution contains approximately 100 mg of caffeine and 20 mg niacinamide.

### EXAMPLES

### Example 1

10 g of niacinamide were added to 100 ml of water with mixing to produce a colorless solution, to which were added 10 g of caffeine with mixing, to produce a colorless solution. The solution was filled into unit-dose packaging at a rate of 1.2 ml per unit dose. The contents of one unit-dose package were added to 8 oz of bottled orange juice to produce a beverage containing approximately 100 mg of caffeine.

### Example 2

The solution from example 1 was filled into bottles fitted with a metering device, such as medicine dropper, pipette, or pump, configured to measure 1.2 ml for dispensation.

### Example 3

7.5 g of niacinamide were added to 200 ml of water with mixing to produce a colorless solution, to which were added 10 g of caffeine with mixing, to produce a colorless solution. The solution was filled into unit-dose packaging at a rate of 2.2 ml per unit dose. The contents of one unit-dose package were added to a 250 ml carton of milk to produce a beverage containing approximately 100 mg of caffeine.

### Example 4

15 g of niacinamide were added to 300 ml of water with mixing to produce a colorless solution, to which were added 20 g of caffeine with mixing, to produce a colorless solution. The solution was filled into unit-dose packaging at a rate of 3.3 ml per unit dose. The contents of one unit-dose package were added to a 12 oz bottle of beer to produce a beverage containing approximately 200 mg of caffeine.

### Example 5

2 g of niacinamide were added to 350 ml of water with mixing to produce a colorless solution, to which were added 10 g of caffeine with mixing, to produce a colorless solution. The solution was filled into unit-dose packaging at a rate of 3.6 ml per unit dose. The contents of one unit-dose package were added to a 14 oz bottle of water to produce a beverage containing approximately 100 mg of caffeine.

### Example 6

5 g of niacinamide were added to 250 ml of water with mixing to produce a colorless solution, to which was added 10 g of caffeine with mixing, to produce a colorless solution. The solution was filled into unit-dose packaging at a rate of 2.6 ml per unit dose. The contents of one unit-dose package were added to a 12 oz bottle of apple juice to produce a beverage containing approximately 100 mg of caffeine.

What is claimed is:

1. A product which allows for the convenient addition of an oral caffeine dosage to a pre-packaged beverage, comprising an aqueous solution of niacinamide in an amount equal to between 20-150 mg, caffeine in an amount equal to the maximum solubility of the caffeine, wherein the total volume of the aqueous solution is less than 8 ml, and the solution is unbuffered.

2. The product of claim 1, wherein the aqueous solution contains at least 90 mg and no more than 200 mg of caffeine per dose.

3. The product of claim 1, wherein the aqueous solution contains at least 20 mg and no more than 150 mg of niacinamide per dose.

4. The product of claim 1, wherein the total volume of the aqueous solution is less than 8 ml

5. The product of claim 1, wherein the total volume of the aqueous solution is less than 7 ml

6. The product of claim 1, wherein the total volume of the aqueous solution is less than 5 ml

7. The product of claim 1, wherein the total volume of the aqueous solution is less than 3 ml

8. The product of claim 1, wherein the product is packaged in a single unit dose container, such as a plastic blow-fill-seal ampoule or a plastic pouch (or tube) where the top is torn off.

9. The product of claim 1, wherein the product is packaged in a multi-dose container capable of delivering a metered dose of 8 ml or less of said aqueous solution to a pre-packaged beverage. such as a bottle-top metered pump dispenser, or a metered liquid dispensing gun.

10. A controlled caffeine delivery system in a single unit dose of less than 8 ml of an unbuffered aqueous solution, comprising up to 200 mg of caffeine and up to 150 mg of niacinamide.

11. An apparatus for providing multiple metered doses of an unbuffered aqueous caffeine solution which can be added to a pre-packaged beverage, said aqueous caffeine solution comprising a total volume of less than 8 ml, up to 200 mg of caffeine and up to 150 mg of niacinamide.

12. A method for delivering a controlled amount of caffeine to a person in need of or desirous of receiving same comprising the steps of providing an unbuffered aqueous caffeine dosage solution with a total volume of 8 ml or less in a single serving container, combining the contents of the packaged aqueous solution with a pre-packaged beverage of choice, consuming the combined contents of the pre-packaged beverage and the aqueous caffeine dosage solution.

13. The method of claim 8, where the taste of the pre-packaged beverage is altered only to the extent of the added caffeine.

14. The method of claim 8, wherein the addition of the aqueous caffeine dosage solution does not significantly alter the taste of the pre-packaged beverage.

15. The method of claim 8, wherein the volume of the aqueous caffeine dosage solution is less than 2% of the total volume of the pre-packaged beverage.
